(19) United States
(12) Patent Application Publication
(10) Pub. No.: US 2005/0252177 A1
(43) Pub. Date: Nov. 17, 2005

(54) Ceramic filter and smoke treatment device

(76) Inventor: Shiro Ishikawa, Maebashi-shi (JP)

Correspondence Address: TOWNSEND & BANTA;c/o PortfolioIP, P.O. Box 52050, Minneapolis, MN, 55402, US

(21) Appl. No.: 10/843,446

(22) Filed: May 12, 2004

(51) Int. Cl. B01D 46/00

(52) U.S. Cl. 55/282.3; 55/523

(57) ABSTRACT

A ceramic filter capable of burning combustible microparticles contained in smoke, without these escaping, and a smoke treatment device using the same are provided. A resin foam to which a ceramic slurry has been applied is fired so as to produce a porous ceramic body having a three-dimensional reticulate structure, at the interior of which is provided a linear electric heating element made of tungsten or the like, to produce a ceramic filter. The ceramic filter is disposed in a duct and a fan is provided so as to draw smoke from the exterior into this duct. Within the duct, a sprinkler pipe for dispersing water is connected downstream of the point at which the ceramic filter is disposed.

### FIELD OF THE INVENTION

The present invention relates to a ceramic filter for installation in incinerator chimneys, diesel automobile exhaust pipes and the like, and to a smoke treatment device using this filter.

### BACKGROUND OF THE INVENTION

Conventional filters fitted along the flow paths of high temperature gases and the like include porous ceramic bodies having a three-dimensional reticulate structure, such as those disclosed in JP-06-33194-A, JP-2507976-B, JP-3170850-B, JP-3186231-B and JP-3287019-B. These are produced by using, as a substrate therefor, a resin foam having a three-dimensional reticulate structure comprising connected internal spaces; immersing this in a ceramic slurry so that the ceramic slurry adheres to the resin foam; and next removing the excess ceramic slurry by compressing this with rollers, centrifuging it or blowing it with air; whereafter the resin foam to which a suitable amount of ceramic slurry has adhered is dried and fired. In this manner a highly porous and heat resistant product is produced, which is suitable for use, not only for exhaust gas from incinerators and automobiles, but also as a high temperature fluid filter for molten metals and the like.

However, while such conventional porous ceramic bodies presented the advantages of resisting degradation under high temperature conditions, and as the result of a physical absorption effect, efficiently trapping smoke from incinerators, as well as DEP (diesel exhaust particles) and the like, with long-term use, progressive clogging increased air-flow resistance and decreased absorption capacity, and there was a risk of particles that had originally been trapped coming loose from the porous ceramic body as a result of fluid pressure.

In view of this problem, in the past it was believed that if a porous ceramic body is disposed, for example, in an incinerator chimney and heated with a burner, it is possible to burn off the trapped incinerator smoke, without allowing it to escape, so as to prevent both external discharge and lowered filter effectiveness. However, there is a problem in that heating the porous ceramic body with a burner incurs major running costs, due to the consumption of large quantities of fossil fuels such as kerosene. Furthermore, heating porous ceramic bodies with a burner presents a disadvantage in that, even if the trapped incinerator smoke is completely combusted, the resulting fire may blow back to the burner side, and this backfire may damage the burner.

### SUMMARY OF THE INVENTION

The present invention attempts to overcome the above problems, and an object thereof is to provide a ceramic filter using a heat resistant porous ceramic body having a three-dimensional reticulate structure, whereby it is possible to burn combustible microparticles, which may be contained in smoke and the like, without allowing the microparticles to escape. The present invention also relates to a smoke treatment device using this ceramic filter.

In order to achieve the aforementioned object, in a first embodiment of the present invention such a ceramic filter is provided comprising: a porous ceramic body having a three-dimensional reticulate structure produced by applying a ceramic slurry to a resin foam, followed by firing; and an electric heating element provided at the interior of the porous ceramic body.

In a second embodiment of the present invention, the ceramic filter of the first embodiment above is provided, further comprising an electrode terminal for supplying power to the electric heating element, a plurality of the porous ceramic bodies being joinable end-to-end or side-by-side by connecting the electrode terminals.

In a third embodiment of the present invention, a smoke treatment device is provided comprising: a duct having an inlet and an outlet; the ceramic filter described above; and a fan for drawing smoke produced at the exterior thereof into the duct.

In a fourth embodiment of the present invention, in the smoke treatment device of the third embodiment described above, a sprinkler pipe for dispersing water within the duct is connected downstream, in terms of the airflow generated by the fan, of the point at which the ceramic filter is disposed.

According to a fifth embodiment of the present invention according to the fourth embodiment above, an ion generator is provided in order to generate anions in the gas which has passed through the ceramic filter.

In a sixth embodiment of the present invention according to the fifth embodiment above, the ion generator comprises a natural mineral ore that releases anions at all times or when heated, or a heat resistant material retaining particles of the mineral ore.

With the ceramic filter according to the present invention, by providing the porous ceramic body having three-dimensional reticulate structure with an internal electric heating element, it is possible for combustible microparticles contained in the exhaust gas of incinerators and automobiles to be efficiently and completely combusted, without these escaping, and without using a burner that consumes large quantities of fuel. Furthermore, by burning off the combustible microparticles, it is possible to maintain good filter efficiency over long periods of time.

Furthermore, since an electrical resistance-heating system is used in place of a burner, the running costs are low and safety is high. The filter according to the present invention can, moreover, be easily installed in such small spaces as an automobile exhaust system.

In addition, a plurality of these porous ceramic bodies can be joined together by connecting the electrode terminals thereof, whereby it is possible to adjust the overall area to the size of the incinerator chimney or automobile exhaust pipe. Meanwhile, a smoke treatment device equipped with the ceramic filter according to the present invention can be installed in tunnels, subway structures, or high-rise buildings, and smoke produced by fires in these structures can rapidly be eliminated, thereby contributing to saving lives.

Furthermore, by connecting a sprinkler pipe that sprinkles water inside a duct that is a part of the smoke treatment device, it is possible to separate and remove, from the gas that has passed through the ceramic filter, suspended matter remaining therein. Since the sprinkler pipe is connected downstream of the position at which the ceramic filter is disposed, the ceramic filter is not cooled as a result of being sprinkled with the water dispersed by the sprinkler pipe.

Furthermore, by providing an ion generator for generating anions in the gas which has passed through the ceramic filter, it is possible to generate anions within the cleaned gas, which are then released into the ambient air. These anions produce such effects as psychological relaxation. Consequently, an effect is achieved wherein, for example, firefighters performing fire-fighting duties are caused to relax by the anion atmosphere, so as to be able to perform their firefighting duties calmly.

### BRIEF DESCRIPTION OF THE DRAWINGS

These and other features, aspects, and advantages of the present invention will be better understood with regard to the following description and accompanying drawings where:

FIG. 1 is a perspective view showing a ceramic filter according to the present invention;

FIG. 2 is a longitudinal cross-sectional view of the ceramic filter shown in FIG. 1;

FIG. 3 is a schematic view showing porous ceramic bodies joined end-to-end;

FIG. 4 is a schematic view showing porous ceramic bodies joined side-by-side;

FIG. 5 is a perspective view showing a second embodiment of the ceramic filter according to the present invention;

FIG. 6 is a traverse cross-sectional view of the ceramic filter shown in FIG. 5;

FIG. 7 is a longitudinal cross-sectional view showing a third embodiment of the ceramic filter according to the present invention;

FIG. 8 is a perspective view showing a second embodiment of the ceramic filter according to the present invention;

FIG. 9 is a side view showing a preferred mode for the smoke treatment device according to the present invention; and

FIG. 10 is a side view showing a variant of the smoke treatment device according to the present invention.

### DETAILED DESCRIPTION OF THE INVENTION

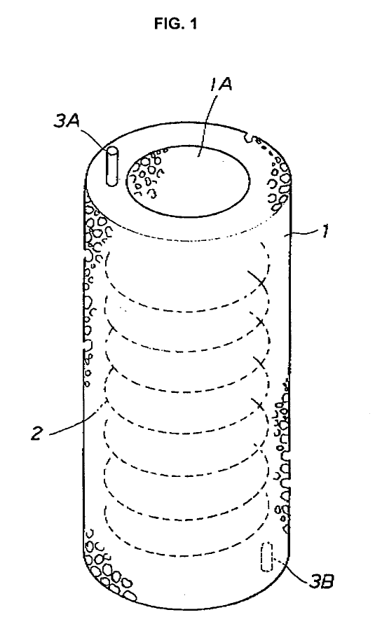

As shown in FIG. 1, a porous ceramic body 1 is cylindrical in shape; this porous ceramic body 1 is provided with an internal linear electric heating element 2 (electric heating wire) and a pair of electrode terminals 3A and 3B, for connecting this electrical heating element to an external power source so as to provide electrical power to the electrical heating element 2.

The substrate for this porous ceramic body 1 is known in the art, being a resin foam having a three-dimensional reticulate structure comprising connected internal spaces, in soft polyurethane foam or the like. This is immersed in a ceramic slurry so that the ceramic slurry adheres to the resin foam. Next, after removing the excess ceramic slurry, the resin foam is dried and fired to produce a three-dimensional reticulate structure wherein the percentage of voids (porosity) is established at 70 to 90%.

Note that the ceramic slurry is produced by admixing a suitable quantity of water to a ceramic powder having good electrical insulation characteristics such as, not only alumina (Al₂O₃) and cordierite (2MgO—2Al₂O₃—5SiO₂), but also zirconia (ZrO₂), zircon (ZrSiO₄), barium titanate (BaTiO₃), silicon carbide (SiC), molybdenum disilicide (MoSi₂), lanthanum chromate (LaCrO₃), or the like. The viscosity of the slurry is established at 50-250 poise.

Furthermore, the excess ceramic slurry may be removed by pressing with rollers, centrifuging or blowing with air. But, in the present example, centrifuging and air blowing are suitable because these will not deform the electric heating element 2. In other words, in the present example, prior to firing the porous ceramic body 1, the electric heating element 2 is placed in the resin foam mold and embedded in the resin foam when this is formed, or it is wrapped around the outer periphery of the resin foam. In this state, the ceramic slurry is applied to the resin foam, whereafter the excess slurry is removed and the resulting product is dried and fired.

Specifically, in the present example, a coiled electric heating element 2 is embedded concentrically around a central hole 1A in the porous ceramic body. Note that a heat resistant wire having a diameter of 1 to 5 mm such as, not only tungsten and tungsten carbide, but also silicone carbide, nichrome (nickel-chromium alloy) or the like can be used for the electric heating element 2.

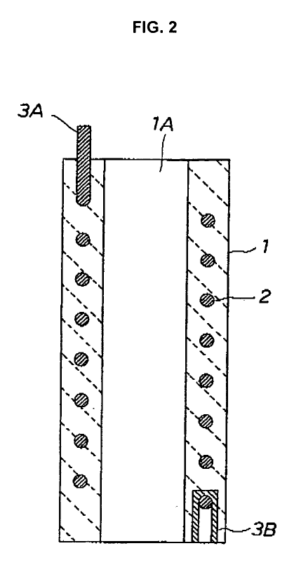

As shown in FIG. 2, one end of the electrical heating element 2 protrudes from an end face of the porous ceramic body 1 to form a pin-shaped electrode terminal 3A, while a recessed electrode terminal 3B is provided at the other end of the electric heating element 2 and comprises a hole having an aperture substantially equal to the external diameter of the electrode terminal 3A. The electric heating element 2 is coated with an electrical insulator, but in cases where electrical insulators such as alumina or cordierite are used for the ceramic slurry, an insulating coating is not necessarily required for the electric heating element 2.

Note that the external and internal surfaces of the electrode terminal 3A and the electrode terminal 3B, formed at either end of the electric heating element 2, are not coated by a ceramic layer. For this reason, after applying the ceramic slurry to the resin foam, the ceramic slurry that adheres to the electrode terminals 3A and 3B is wiped off, or after firing the ceramic slurry, the sintered ceramic adhering to the electrode terminals 3A and 3B is scraped off, so as to expose the conductors.

Thus, if a ceramic filter such as described above is, for example, disposed in an incinerator chimney, and the electrode terminals 3A and 3B are connected to an external power source by way of power line running through a heat resistant conduit (not shown in the drawings) so as to provide current to the electric heating element 2, the non-combusted smoke from the incinerator that is trapped by the porous ceramic body 1 is burned off, and the smoke passing through the central hole 1A is indirectly heated by the electric heating element 2 so as to be completely combusted when passing through the central hole 1A.

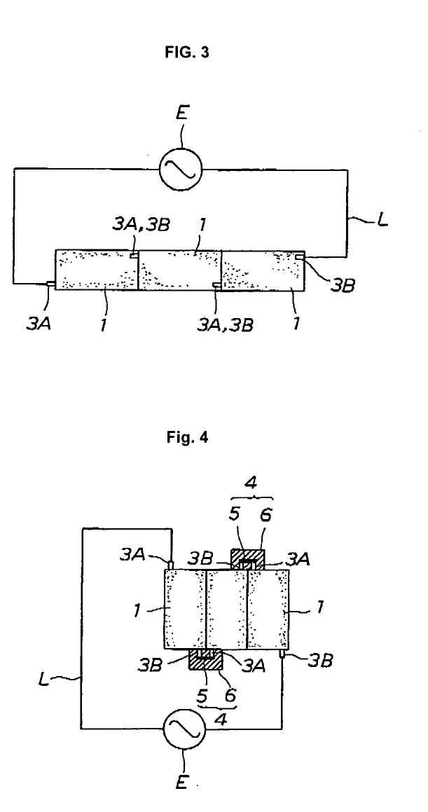

Depending on the length of the chimney, as shown in FIG. 3, the male electrode terminal 3A may be inserted into the female electrode terminal 3B so as to directly connect (mate) the two electrode terminals 3A and 3B, whereby it is possible to join a plurality of porous ceramic bodies 1, end-to-end in the lengthwise direction. In this case, by connecting the electrode terminals 3A and 3B, located at either end of the porous ceramic bodies, to an external power source E with a power line L, it is possible to provide power to all of the heating elements 2, which are connected in series, so that these generate heat.

Furthermore, depending on the diameter of the chimney, as shown in FIG. 4, it is possible to join a plurality of porous ceramic bodies 1 in a side-by-side arrangement. In this case, one end of the electric heating element 2 protrudes from each end-face of the porous ceramic body 1 to form electrode terminals 3A and 3B, and the adjacent electrode terminals 3A and 3B are connected by a connector 4. Note that both ends of connector 4 have a structure wherein a fitting 5, which comprises a good conductor and is coated with a fire resistant material 6, mates with the electrode terminals 3A and 3B.

In the foregoing, one embodiment of the present invention has been described, but the ceramic filter according to the present invention is not only suitable for installation in chimneys in order to eliminate smoke from incinerators, but can also be positioned in the exhaust systems of automobiles so as to eliminate DEP and enhance the sound muffling effect. Furthermore, this can be provided in forced air heating systems such as kerosene fan-heaters, so as to generate heated air and burn off fine particles contained in the forced air, thus enhancing the order elimination effect.

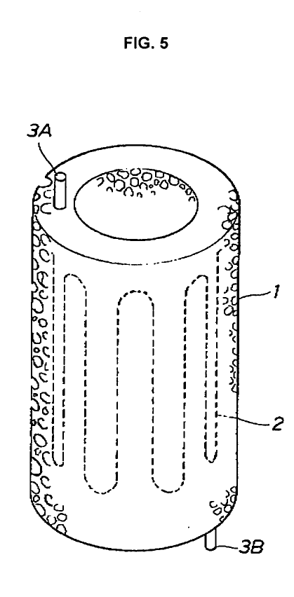

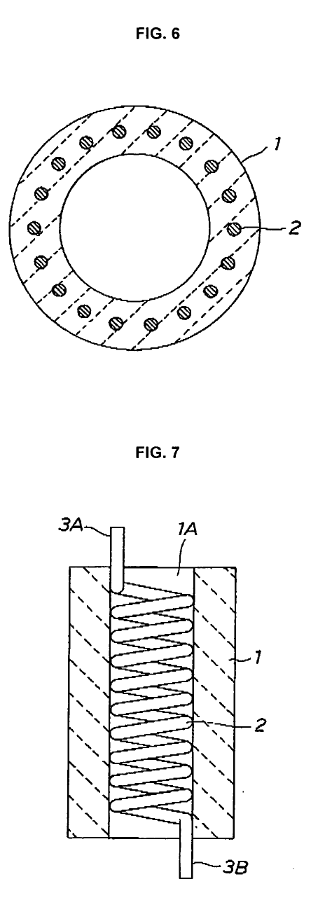

Furthermore, the ceramic heater according to the present invention is not limited to that described above, and variants on the porous ceramic body 1, the electric heating element 2, and the like are possible. FIG. 5 and FIG. 6 show an example wherein the electric heating element 2 is snaked back and forth in an undulating pattern so as to be embedded around the central hole 1A in the porous ceramic body. In this example, one end of the electric heating element 2 protrudes from each of the end faces of the porous ceramic body 1 to form electrode terminals 3A and 3B.

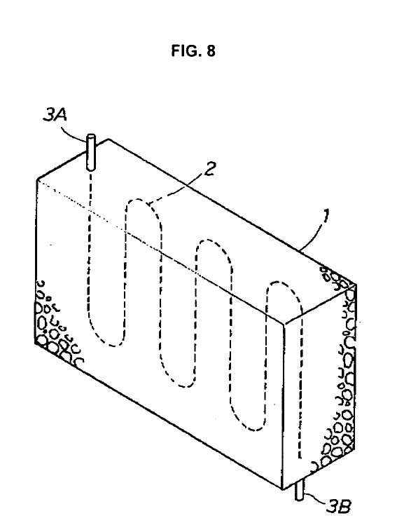

Next, FIG. 7 is an example wherein a coiled electric heating element 2 is packed into the central hole 1A in the porous ceramic body. Consequently, roller pressure can be applied to remove the excess ceramic slurry. The electric heating element 2 can then be united with the porous ceramic body 1 after this has been fired. Furthermore, in addition to cylindrical shapes, the porous ceramic body 1 maybe a rectilinear body having the electric heating element 2 embedded at the interior thereof, as shown in FIG. 8.

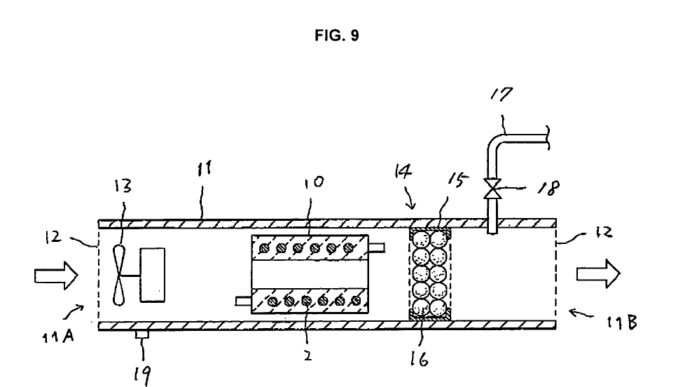

A smoke treatment device using a ceramic filter such as that set forth above, as shown in FIG. 9, comprises a ceramic filter 10 such as that described above is housed in a cylindrical duct 11. At either end of the duct 11 are provided an intake 11A and an outlet 11B. Screens 12 (perforated plates, wire mesh, or lattices) are mounted on the intake 11A and the outlet 11B so as to prevent birds or large insects from entering. Furthermore, a fan 13 is provided within the duct 11, and this fan 13 draws smoke produced at the exterior thereof into the duct 11.

In other words, by running the fan 13, an airflow is generated within the duct 11, moving in the direction that travels from the intake 11A toward the outlet 11B. Note that the fan 13 does not necessarily have to be disposed within the duct 11, but can also be mounted at one end of the duct 11, facing the intake 11A or the outlet 11B. Meanwhile, an ion generator 14 is provided downstream, in terms of the airflow generated by the fan, from the point at which the ceramic filter 10 is disposed, so that the ion generator 14 generates anions in the gas that has passed through the ceramic filter 10 (air from which soot has been removed).

This ion generator 14 houses a natural mineral ore 16 within an air-permeable case 15. Radon ore, radium ore, uranium ore, garnet ore, tourmaline ore, power stone (quartz porphyry), manganese ore, granite, feldspar, Chinese power stone, or the like, which release anions at all times, or when heated, can be used as the mineral ore 16. Note that, in place of the mineral ore 16 described above, blocks of heat resistant material may be used, wherein particles of this mineral ore (powders or granules) have been admixed to cement and set therewith, or wherein these have been mixed with clay and fired. Thus, by means of the ion generator 14 described above, anions capable of producing a psychologically relaxing effect are released into the gas which has passed through the ceramic filter 10 and diffused to the exterior from the outlet 11B.

Furthermore, a sprinkler pipe 17 is connected downstream from both the ceramic filter 10 and the ion generator 14 so as to sprinkle water into the duct 11 from one end thereof. Note that the sprinkler pipe 17 is connected at the other end thereof to a water supply, by way of a pump (not shown in the drawings). A valve 18 is provided at a midpoint on the sprinkler pipe 17. Thus, this sprinkler pipe 17 serves to bring gas that has passed through the ceramic filter 10 into contact with water, so that suspended matter remaining in this gas can be separated and removed from this gas. Furthermore, it is also possible to douse the fire which is generating the smoke by causing the water which has been sprinkled to flow out from the outlet 11B.

Note that the electric heating element 2 comprised by the ceramic filter, the fan 13 and the valve 18 are connected by power lines to a controller (not shown in the drawings) and when smoke is detected by a sensor 19 mounted on the outer circumference of the duct 11 or the like, power is supplied to the electric heating element 2, the fan 13 is operated, and the valve 18 is opened. It will be noted that a temperature sensor or a gas sensor, which outputs a signal when it senses carbon monoxide or the like, can be used as the sensor 19.

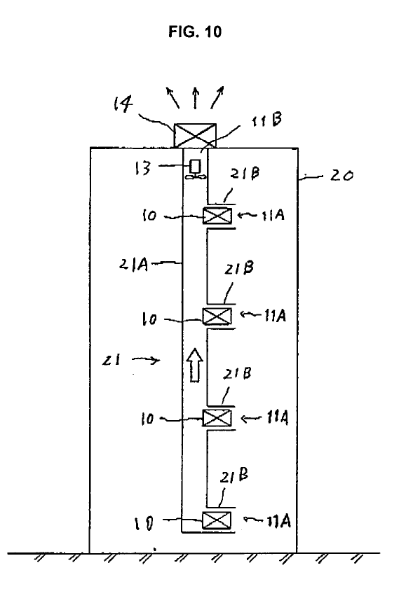

Here, when provided in a tunnel or subway structure, in the event of a tunnel fire or a subway fire, the smoke treatment device described above rapidly eliminates the smoke generated thereby, thus greatly contributing to saving lives. Furthermore, such configurations are possible as that shown in FIG. 10, wherein a duct 21 in a high-rise building 20 comprises a main passage 21A and branch passages 21B, and wherein a ceramic filter 10 is provided in each of the branch passages 21B. Note that, in the present example, the intakes 11A, at one end of each of the branch passages 21B, open on each floor of the building, and the air outlet 11B opens on the roof of the building 20 at the top of the main passage 21A.

Furthermore, the fan 13 is provided in the main passage 21A in order to draw smoke generated by a fire in the building 20 into the intakes 11A, and an ion generator 14, such as described in the foregoing example, is provided facing the air outlet 11B on the roof of the building 20. Thus, with a smoke treatment device such as shown in FIG. 10, smoke generated by a fire in the building 20 passes through the ceramic filter 10 and is cleaned; anions are generated in the cleaned gas by the ion generator 14, and this is dispersed into the ambient air.

1. A ceramic filter comprising:
a porous ceramic body having a three-dimensional reticulate structure produced by applying a ceramic slurry to a resin foam, followed by firing; and
an electric heating element provided at the interior of said porous ceramic body.

2. The ceramic filter recited in claim 1, further comprising an electrode terminal for supplying power to said electric heating element, a plurality of said porous ceramic bodies being joinable end-to-end or side-by-side by connecting said electrode terminals.

3. A smoke treatment device comprising:
a duct having an inlet and an outlet;
the ceramic filter recited in claim 1; and
a fan for drawing smoke produced at the exterior thereof into said duct.

4. The smoke treatment device recited in claim 3, wherein a sprinkler pipe for dispersing water within said duct is connected downstream, in terms of the airflow generated by said fan, of the point at which said ceramic filter is disposed.

5. The smoke treatment device recited in claim 3, further comprising an ion generator for generating anions in gas which has passed through said ceramic filter.

6. The smoke treatment device recited in claim 5, wherein said ion generator comprises a natural mineral ore that releases anions at all times or when heated, or a heat resistant material retaining particles of said mineral ore.

7. A smoke treatment device comprising:
a duct having an inlet and an outlet;
the ceramic filter recited in claim 2; and
a fan for drawing smoke produced at the exterior thereof into said duct.

8. The smoke treatment device recited in claim 4, further comprising an ion generator for generating anions in gas which has passed through said ceramic filter.
